(19) United States
(12) Patent Application Publication
(10) Pub. No.: US 2010/0109369 A1
(43) Pub. Date: May 6, 2010

(54) LIFT GATE ASSIST MECHANISM

(76) Inventor: JOEL C. SMITH, JR., Charleston, SC (US)

Correspondence Address: NEXSEN PRUET, LLC, PO DRAWER 2426, COLUMBIA, SC, 29202-2426, US

(21) Appl. No.: 12/611,275

(22) Filed: Nov. 3, 2009

Related U.S. Application Data
(60) Provisional application No. 61/110,725, filed on Nov. 3, 2008.

(51) Int. Cl. B62D 33/03; B62D 65/00; B62D 33/08

(52) U.S. Cl. 296/57.1

(57) ABSTRACT

The invention disclosed herein relates to a novel mechanism for assisting in opening and closing the lift gate on a vehicle, namely, a trailer. The lift gate assist mechanism is attached to the back of the closed lift gate and cables extend from the mechanism to a connection point on the trailer itself, allowing ease of installation on a variety of trailers. The mechanism is particularly convenient to attach as an after-market product. The mechanism comprises one or more strong outer casings having one or more concentric springs contained therein, where one end of the springs are attached to one end of the casing and the second end of the springs is attached to the bed or some other portion of the vehicle. The mechanism also provides extra strength to the lift gate to enable it to support additional weight of objects when they are rolled onto or off of the trailer. The invention also relates to the method for adding the novel lift gate assist mechanism to the lift gate on a trailer.

### PRIORITY CLAIM

Priority is claimed to U.S. provisional patent application No. 61/110,725, Lift Gate Assist Mechanism, filed Nov. 3, 2008, which is incorporated herein in its entirety by reference

### BACKGROUND OF THE INVENTION

Trailers are useful vehicles for carrying supplies and pieces of equipment. The types of trailers that can utilize the invention disclosed herein include not only those types of trailers that have an integral means of locomotion (e.g., the trailer portion of a truck), but also trailers that can be separated from the means of locomotion (e.g., a trailer that is attached to the back of a pick-up truck). The trailers can be open (i.e., without sidewalls or a roof), or they can be fully or partially enclosed.

Most trailers have a lift gate, which generally is the rear closure of the trailer and which can be lowered to ground level or the level of a dock and which enables items to be rolled onto the trailer. Lift gates are generally heavy and require a reasonably large force to not only raise the lift gate, but also to lower the lift gate without having it suddenly drop to the ground or dock.

Various types of spring mechanisms have been developed to counteract the weight of the lift gate and, therefore, to make it easier for a user to lower or raise the lift gate. Many prior art mechanisms incorporate springs that are mounted on the sides of the trailer and contain a cable that is attached to the lift gate. Attaching such a mechanism to the side of the trailer requires the installer to have a wide variety of devices, since there is wide variety in trailer design. Some trailers have sidewalls, and the mechanisms must fit on the existing sidewall (e.g., U.S. Pat. No. 6,126,223 to Rayburn). Others have no sidewalls, and the mechanism must be attached to the bed of the trailer or a structure must be attached to the trailer bed to accommodate the mechanism. Others might have a mechanism within a part of the trailer, making them more appropriate for the vehicle manufacturer to incorporate. For example, one such device is a tension mechanism installed within the lift gate (e.g., U.S. Pat. No. 6,820,910 to Tan, et al.) or the mechanism might contain a torsion bar (e.g., U.S. Pat. No. 6,793,263 to Bruford, et al.) or an energy storage device within the vehicle body (e.g., U.S. Pat. No. 6,773,047 to Gruber). All of these prior mechanisms require a significant amount of engineering or re-engineering of the vehicle or trailer to accommodate the mechanism, which makes them particularly unsuitable for the vehicle after-market.

### SUMMARY OF THE INVENTION

The present invention is a novel mechanism for assisting in opening and closing a lift gate on a vehicle having a lift gate such as a trailer. The lift gate assist mechanism is attached to the back of the closed lift gate. A cable extends from the mechanism to a connection point on the trailer itself. Whether the trailer has sides or no sides, whether the trailer is open or closed, the end of the cable is simply attached to such a connection point without having to modify the entire mechanism to adapt to the vehicle. As such, the mechanism is particularly convenient to attach as an after-market product.

The mechanism comprises one or more strong outer casings having one or more springs contained therein, where one end of the springs is attached to one end of the casing and the second end of the springs is attached to the bed or other portion of the vehicle.

In addition, the mechanism contains a unique configuration of springs, preferably with two concentric springs, one within the other, with both springs attached to each other.

The invention also relates to the method for making the novel lift gate assist mechanism for raising and lowering the lift gate on a trailer.

These and other features and their advantages will be readily apparent to those skilled in the art of trailers and in particular mechanisms that assist with the raising and lowering of trailer lift gates, from a careful reading of the Detailed Description of Preferred Embodiments, accompanied by the following drawings.

### BRIEF DESCRIPTION OF THE DRAWINGS

In the figures,

FIGS. 1A-C show rear perspective views of a trailer carrying the lift gate assist mechanism with the lift gate closed (FIG. 1A), a view with the lift gate open (FIG. 1B), and a detailed, cross-sectional view of a typical assembly of the novel mechanism (FIG. 1C);

FIGS. 2A, B show two views of the connection of the mechanism to the lift gate, including a detailed view of the connection to the left side of the lift gate into which one end of the casings of the mechanism is slipped to attach the mechanism to the lift gate (FIG. 2A) and a top view of the present lift gate mechanism (FIG. 2B);

FIGS. 3A-E show five variations for connecting the cable directly to trailer sidewalls of different heights (FIGS. 3A and 3C), to the bed of a trailer (FIG. 3E), and to a trailer bracket carried on a trailer sidewall or bed (FIGS. 3B and 3D);

FIG. 4 shows a cross-sectional, end view of an example of a direction pulley bracket carrying a pulley for changing the direction of the cable.

### DETAILED DESCRIPTION OF PREFERRED EMBODIMENTS

The present invention is a novel mechanism for assisting in the raising and lowering of the lift gate on a vehicle and a novel way of attaching the mechanism to a vehicle. In many cases, the vehicle is a trailer, in particular an open trailer for carrying equipment and supplies. For example, the mechanism is particularly useful on a trailer for carrying lawn maintenance equipment and chemicals. Lift gates on such trailers are generally quite heavy because of the lift gate structure. Despite this fact, these trailers are frequently purchased without a mechanism for reducing the force needed to raise and lower the lift gate. Often, the purchaser of such trailer must locate an after-market product to assist in raising and lowering the lift gate.

Mechanisms available to date have been specific to the characteristics of the vehicle. If the purchaser has a vehicle with sidewalls, he could purchase a mechanism that fits the particular design of the sidewalls. If there are no sidewalls, the purchaser would need some other type of mechanism. A seller or an installer who adapts trailers to a particular use would need to have available a variety of these mechanisms to be able to outfit the variety of trailers available in the marketplace and the variety of end-uses for these trailers.

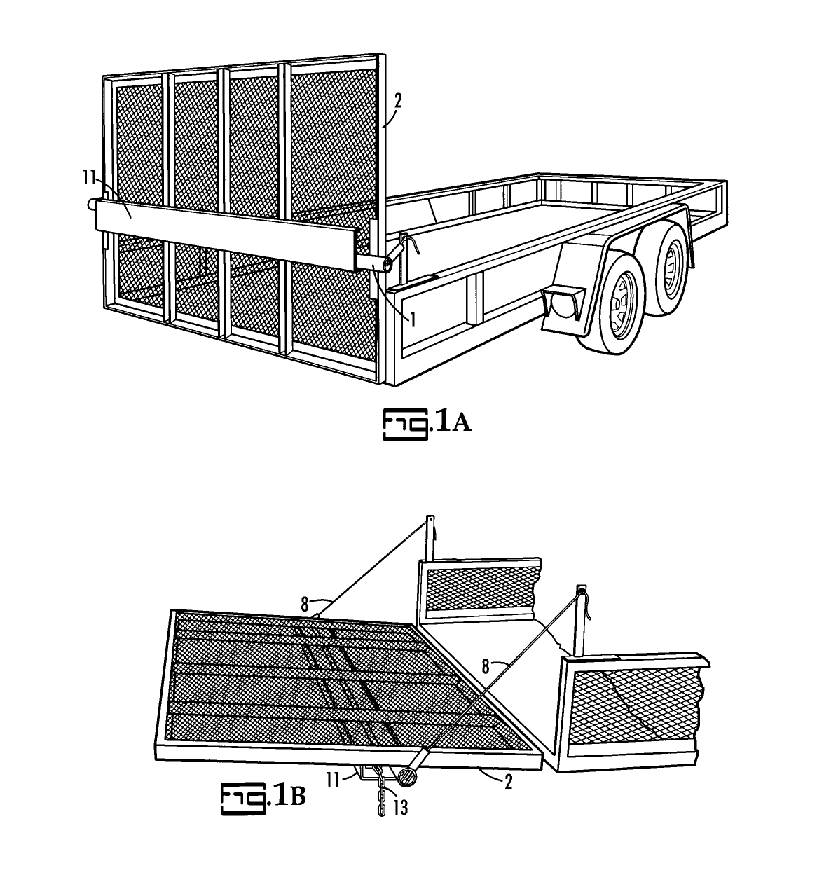

The lift gate assist mechanism presently described is attached to the back of the closed lift gate. Cable extending from the mechanism connects to the trailer itself. Referring now to the drawings, FIGS. 1A and 1B show two rear perspective views of the mechanism attached to a trailer. FIG. 1A shows a rear view of a trailer with a lift gate 2 in the up or closed position, and FIG. 1B shows lift gate 2 in the down or open position, with the lift gate assist mechanism attached to the trailer lift gate 2, including an optional cover 11 carried by the lift gate assist mechanism. The cover preferably hides the lift gate assist mechanism and can be used to carry advertising. The lift gate assist mechanism comprises at least one strong tubular casing 1 attached to the back side of the closed lift gate 2. As shown in FIG. 1C, casing 1 contains two springs 3 and 4, one spring 4, being smaller and generally within the other spring 3, and both attached to each other. The first ends 5 of the springs 3, 4, are secured to one end of the casing 6 using a chain 13 or other securing means, while the other ends 7 of the springs 3, 4, are attached to a cable 8 that extends out of the second end of the casing 9. From second end of casing 9, cable 8 extends through a direction pulley bracket 18 that is carried on second end casing 9. Direction pulley bracket 18 carries pulley 24 which directs cable 8 to smoothly turn and extend out of direction pulley bracket 18 toward the bed or sidewall 10 of the trailer. The cable 8 is then attached to the bed or sidewall 10 of the trailer or to a bracket 16 attached to the bed or a sidewall 10 of the trailer.

The lift gate assist mechanism may incorporate two casings 1, each one having a separate cable 8 connected to a different side of the trailer. However, a single casing 1 may be suitable in some cases, such as lighter lift gates. Also, more than two casings 1 may be appropriate in other cases, such as heavier lift gate. The casings 1 are mounted to lift gate 2, are generally parallel to each other, and may be separated from each other by a distance equal to or less than the height of the mechanism cover 11. Mechanism cover 11 is generally connected to lift gate 2 by welded or bolted supports that carry casing 1. When used, mechanism cover 11 covers the entire lift gate assist mechanism so that it is not visible when viewing lift gate 2 when closed. Mechanism cover 11 so far serves two optional purposes: carrying advertising and concealing the present lift mechanism for better appearance.

Attachment of casings 1 to lift gate 2 provides additional strength to gate 2 for supporting the weight of objects being rolled on the lift gate 2 into or out of the trailer. The optional mechanism cover 11 attached to the casings 1 provides even more strength to the lift mechanism and support for lift gate 2, a third purpose.

Casings 1 can be attached at various heights above the ground to lift gate 2, the exact location dictating the mechanical advantage provided by the lift gate assist mechanism and strength of springs 3, 4, required to assist in raising and lowering of lift gate 2. Preferably the lift gate assist mechanism is located approximately the same height above the connection of lift gate 2 to the bed of the trailer as the connection point of cable 8 to the bed of the trailer and most preferably approximately half-way up lift gate 2. For example, if cable 8 is attached to sidewall 10 of a trailer, the top of which sidewall 10 is 12 inches above the bed of the trailer, the casings should preferably be approximately 12 inches above the location where lift gate 2 connects to the bed of the trailer. Alternatively, if lift gate 2 is 4 feet in height, casings 1 can be located approximately at the midpoint or about 2 feet above the base of lift gate 2.

Also, the location of the connection of casings 1 to lift gate 2 should be such that, when lift gate 2 is fully opened, spring or springs 3, 4 should not extend more than the maximum recommended extension.

Casings 1 are generally tubular pipe made out of galvanized or carbon steel, stainless steel, aluminum, strong plastics or other durable materials. Optionally casings 1 can be painted or otherwise coated. Preferably, casings 1 are galvanized steel. The inside diameter (ID) of casings 1 must be sufficiently large to accommodate springs 3, 4 within casings 1. Typically the ID ranges from about one inch to 2 inches, preferably from about 1⅛ inches to about 1⅞ inches. The wall thickness of casings 1 is generally about 1/16 inches, so that the typical outside diameter (OD) of casing 1 ranges from about 1⅛ inches to about 2⅛ inches. Casings 1 should be at least as long as is needed to enclose springs 3, 4 at their maximum stretch length. However, casings 1 should generally not be longer than the trailer is wide, and certainly not longer than can be accommodated when attached to lift gate 2. (For example, it is possible for casings 1 to be longer than the width of lift gate 2 if casing 1 is attached diagonally to lift gate 2.)

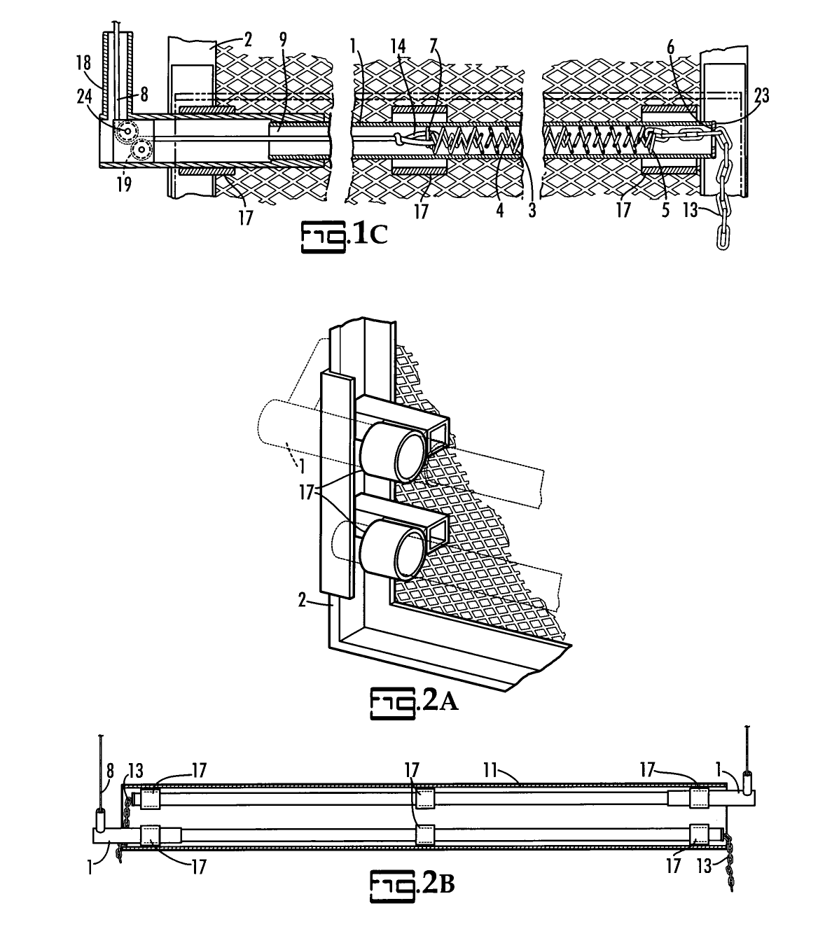

Casings 1 can be attached to the rear of lift gate 2 using any typical connection means, for example (1) U-bolts or (2) pieces of pipe having slightly larger diameter than the casing, these pieces being welded to lift gate 2 or, as shown in FIG. 2B, other support means attached to the lift gate through which the casings can slide 17. Preferably casings 1 are attached to lift gate 2 via the additional use of support means 17 attached to the left and right side of lift gate 2 into which the casing slips. Support means 17 are illustrated in FIG. 2A, which shows support means 17 attached to a bracket on the left side of the lift gate 12. As shown, one end of casings 1 is slipped through support means 17 to attach the mechanism to lift gate 2. Though not shown in FIG. 2A, a similar bracket would be attached to the right side of lift gate 2 to hold the opposing end of casings 1 and secure attachment of casings 1 to lift gate 2.

Optional mechanism cover 11 that may conceal casings 1 can be attached either to lift gate 2 or casings 1 themselves. Preferably, mechanism cover 11 is connected to casings 1 via tubular components soldered to the plate through which casings 1 can slide.

The most preferred assembly involves attaching mechanism cover 11 and side brackets to lift gate 2, with casings slid through tubular components on both mechanism cover 11 and brackets 17.

As shown in FIG. 1C, each casing 1 generally contains two springs 3 and 4, one being contained within the other, with springs 3, 4 connected to each other at the ends. This means that two smaller springs can be used rather than a single larger one. Smaller springs are generally less expensive. In addition, when two springs are used, if one breaks, the second continues to support lift gate 2, which reduces the likelihood that lift gate 2 will suddenly fall on the operator trying to lift or lower the lift gate. Thus, the use of two springs is a safety measure. Springs 3, 4 generally need to be sufficiently short so that, at their maximum stretch, they are fully contained within casing 1.

Typically springs 3, 4 are approximately 15 to 35 inches long, preferably about 20 to 30 inches long and most preferably about 25 inches in length for a lift gate 2 that is 6 feet wide. In the case where two springs 3, 4 are used, one spring should be sufficiently smaller in diameter 4 than the other 3 so that the smaller one can fit within the larger one as shown in FIG. 1C.

Both springs should preferably be the same length and attached to each other at the ends 5, 7. As shown in FIG. 1C, the first ends of the springs 5 may be secured to a first end of a casing 6. As FIG. 1C also shows, there can be a chain or similar device 13 at the first end of the casing 6. Chain 13 allows the springs 3, 4 to be secured to a plate 23 at the first end of the casing 6 so that tension on springs 3, 4 can be adjusted. Referring again to FIG. 1C, opposing second end of the springs 7 is attached to cable 8, either directly or via attachment means 14, for example a metal ring, cable connector, “quick link”, shackle, rope thimble, spring hook, cable clamp, or similar device.

Cable 8 attached to springs 3, 4 extends out of the casing 1 and around and between rollers 19 carried in pulley 24 which smoothly turn the direction of cable 8 toward the connection point on the trailer.

The strength of the springs 3, 4 in each casing 1 should be sufficiently strong so that the combined strength of all springs 3, 4 in all casings 1 is sufficiently strong to dampen the movement of lift gate 2 and make it easier to raise and lower lift gate 2. For a 200 pound lift gate 2, approximately 100 pounds of spring 3, 4 strength on each side should be sufficient, with a 120 or 130 pound spring 3 being used on each side along with a 70 pound spring 4 contained within each of the larger springs 3. (Note, the strength of springs is often described assuming that the springs will be used in pairs. For example, when describing springs sufficient to counterbalance a 100 pound garage door, a pair of springs, each described as a 100 pound spring, will typically be used. In reality, each of the two springs is capable of lifting only 50 pounds.) A typical 130 pound spring (actually capable of lifting 65 pounds) might have an outer diameter (“OD”) of about 1½ inches and an inner diameter (“ID”) of about 1¼ inches, the ID of which is sufficiently large to allow the 70 pound spring to fit within the 130 pound spring. The dimensions of the springs 3, 4 are not critical and can be varied based on the size of the components (i.e., weight of the lift gate 2, length of casings 1, travel distance of cable 8 when lift gate 2 is opened, etc.).

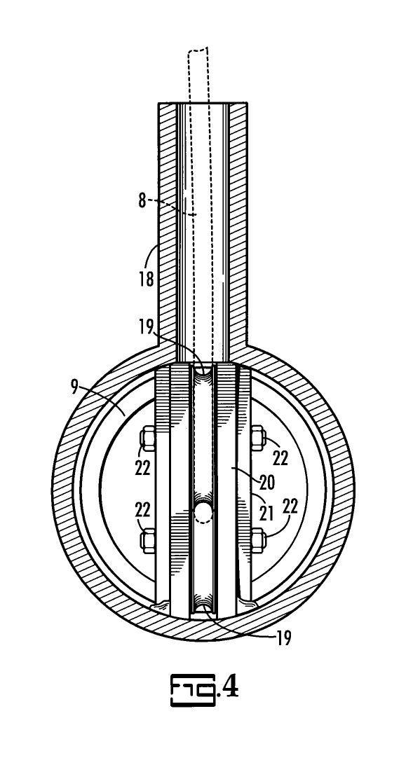

Pulley 24 which changes the direction the cable can be constructed in various ways. FIG. 4 shows an example of a preferred construction of pulley 24 carried inside a direction pulley bracket 18. As FIG. 4 shows, pulley 24 can contain rollers 19, to change the direction of cable 8 and smoothly direct it toward its connection point on the trailer. Two opposing steel plates 21 are bolted 22 to rollers 19, and welded to direction pulley bracket 18 to hold the shaft of direction pulley bracket 18 in alignment with second end of casing 9. Direction pulley bracket 18 has a slightly larger in diameter than second end of casing 9 so that it can be carried on second end of casing 9 and freely rotate as lift gate 2 is raised or lowered. Accordingly, cable 8 continuously points towards the connection point on the trailer. Note that, because of the various possible locations for mounting the casings 1 on lift gate 2 and the various locations for connecting cable 8 to the trailer, cable 8 might be raised in elevation as it moves from directional pulley bracket 18 to the trailer, or it might be lowered in elevation as shown in FIG. 5A and 5B.

Since rollers 19 are moving parts a lubricant to reduce friction is frequently needed. As a substitute for lubricant, pieces cut from self-lubricating plastic sheeting 20 such as TEFLON polytetrafluoroethylene sheeting made by DuPont, or a similar material such as NYLATRON nylon plastic made by Quadrant or ultra high molecular weight polyethylene such as DYNEEMA made by Royal DSM, can be used as shown in FIG. 4. As shown, plastic sheeting 20 is cut into pieces slightly larger than steel plates 21 and act as lubricant both for the rotation of rollers 19 and for rotation of direction pulley brackets 18 around the end of casing 1.

In the foregoing preferred embodiment, one pulley, pulley 24, is used to change the direction of cable 8 with directional pulley bracket 18. However, it will be clear to those of ordinary skill that, depending upon the point of attachment of cable 8 to lift gate 2, one or more additional pulleys may be used to more efficiently direct cable 8 from vertical to horizontal. By understanding direction pulley bracket 18, it will be seen that direction pulley bracket 18 may be extended or duplicated to provide such additional pulleys 24.

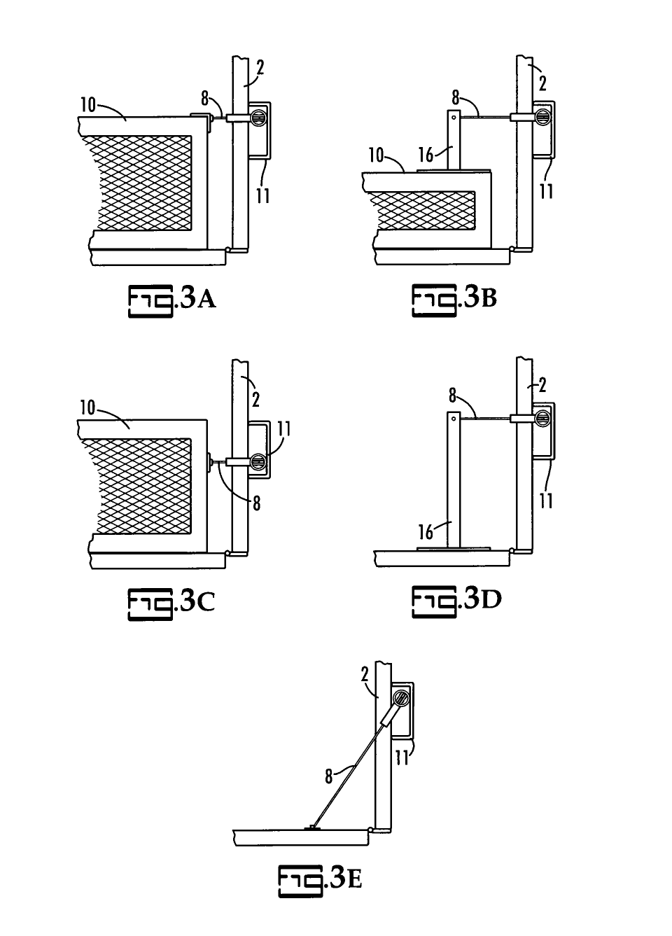

Several ways for connecting cable 8 to the trailer are illustrated in FIGS. 3A-3E. For these illustrations, the end of only one casing 6—that which carries direction pulley bracket 18 for directing cable 8—is shown. Though in many cases a second casing 1 is used in the lift gate assist mechanism, the end of this second casing is not illustrated. Where a second casing 1 is used it is attached to lift gate 2 in an opposing relationship to the first casing, meaning that the components in the interior of the casing are oriented to pull in an opposite direction to the first casing when lift gate 2 is raised or lowered. If the trailer has a sidewall 10, cable 8 can be connected to the top, side or end of sidewall 10. If there is no sidewall 10, cable 8 can be connected to a trailer bracket 16, as shown in FIG. 3B, that is connected to the bed of the trailer. Alternatively, cable 8 can be connected directly to a bracket connected to sidewall 10, the bed itself or any other part of the trailer. Preferably cable 8 is connected to a point located in the rear-most portion of the trailer so that, when lift gate 2 is lowered, extended cable 8 does not contact any part of the trailer. Various locations for attaching cable 8 to the trailer are shown in FIG. 3, with (A) showing attachment directly to the top of sidewall 10, (B) showing attachment to trailer bracket 16 attached to the top of sidewall 10, (C) showing attachment to a point on sidewall 10 aside from the top, (D) showing attachment to a trailer bracket 16 attached directly to the bed of the trailer, and (E) showing attachment of cable 8 directly to the trailer bed.

Wire cable 8 of sufficient strength to support the forces applied by the above lift gate assist mechanism is preferably used. Alternate equivalent materials are also suitable. Connectors of sufficient strength and durability are used throughout, e.g., grade 8 bolts are preferred.

Further variations are contemplated as being incorporated within the invention. For example, if the trailer has a lift gate 2 on the side of the vehicle rather than on the rear, the invention can certainly be accommodated to apply to lift gate 2 on the side. Similarly, if lift gate 2 is divided into two portions, each being half the width of full lift gate 2, or if each of lift gate 2 portions is only sufficiently wide for a wheel to roll or for a person to walk thereon, variations in the mechanism are possible. For example, multiple narrower casings 1 can be used on each portion of the lift gate 2. Alternatively stronger or shorter springs 3, 4 can be used. In addition, the location of casings 1 can be moved, for example to the space beneath the lift gate 2 or beneath the bed of the trailer.

Furthermore, the invention also applies to a method for constructing the lift gate assist mechanism as discussed herein.

The following example is intended to further illustrate, but not limit, the scope of the invention:

A trailer having dimensions of 6 feet wide, 6 feet long was purchased. The trailer had sidewalls 10 extending one foot above the bed and contained a lift gate 2 4 feet tall that extended across the entire 6 foot width of the trailer. To install a lift gate assist mechanism to assist in raising and lowering the lift gate, the following major components were used:

Two casings 1, made of 5′10″ long 079 galvanized steel tubing, approx. 1¾ inch ID, approx. 1⅞″ OD;

Two 70 pound springs 4 having OD of approx. 1″ OD, each 25 inches long; Two 130 pound springs 3 having ID of approx. 1¼″ ID, each 25 inches long (e.g., a model #7687 extension spring made by National);

Wire cable 8 of sufficient strength to support the weight of the 200 pound lift gate 2 (plus the added components attached to the lift gate;

Trailer brackets made of angle iron and flat bar of sufficient strength (generally about ⅛ inch or thicker);

The 70 pound spring 4 was inserted into the 130 pound spring 3, and connected to a chain 13 using a cable connector. The second end of both springs 7 was connected to a cable 8 using a cable connector. Chain 13 at one end of the springs 5 was connected to one end of the casing 6 using a plate 23 similar to that shown in FIG. 1. Cable 8 at the second end of the springs 7 was threaded through the second end of the casing 9, and through pulleys similar to that shown in FIG. 1(C) to a trailer bracket connected to the sidewall 10 of the trailer.

An optional mechanism cover 11 was slid over the casings.

A similar mechanism was assembled for the second casing 1, but reversed in sequence so that cable 8 was attached to a trailer bracket on the side wall on the other side of the trailer.

Both casings 1 were attached to lift gate 2 by slipping them through pieces of pipe 17 connected to lift gate 2. The casings were attached at about the mid-height of lift gate 2; with one casing 1 attached two inches above the second casing 1.

Casings 1 were attached to support means 17 carried on side brackets 12. Direction pulley brackets 18 were attached (with several pieces of lubricant sheet inserted therein).

Those familiar with vehicle lift gates and in particular mechanisms that assist with the raising and lowering of trailer lift gates will appreciate that many modifications and substitutions can be made to the foregoing preferred embodiments of the present invention without departing from the spirit and scope of the present invention, defined by the appended claims.

What is claimed is:

1. A lift gate assist mechanism for assisting the raising and lowering of a lift gate attached to a trailer, said mechanism comprising:
(a) a first spring having a first end and an opposing second end;
(b) means proximate to said first end of said first spring for securing said first end of said first spring;
(c) a cable having a first end and an opposing second end, said first end of said cable being connected to said second end of said first spring, and said second end of said cable being connected to said trailer, said first end of said cable having a direction parallel to said first spring; and
(d) a pulley proximate to said second end of said first spring for changing said direction of said cable.

2. The lift gate assist mechanism as recited in claim 1, further comprising a chain having a first end and an opposing second end, said first end of said first spring being attached to said second end of said chain, and wherein said securing means further comprises a plate having a hole formed therein for receiving said first end of said chain.

3. The lift gate assist mechanism as recited in claim 1, further comprising a casing, said casing having a first end, an opposing second end, and an interior, said first spring being in said interior of said casing.

4. The lift gate assist mechanism as recited in claim 3, further comprising a plate carried by said first end of said casing, said first end of said first spring being attached to said plate.

5. The lift gate assist mechanism as recited in claim 1, further comprising a direction pulley bracket having said at least one pulley carried therein.

6. The lift gate assist mechanism as recited in claim 5, further comprising a casing, said casing having a first end, an opposing second end, and an interior, said first spring being in said interior of said casing, said direction pulley bracket being carried by said second end of said casing.

7. The lift gate assist mechanism as recited in claim 1, further comprising a second spring carried concentrically within said first spring.

8. A trailer with a lift gate assist mechanism, said trailer comprising:
(a) a trailer;
(b) a lift gate carried by said trailer; and
(c) at least one lift gate assist mechanism carried by said trailer having
(1) a first spring having a first end and an opposing second end,
(2) a first casing having a first end, an opposing second end, and an interior, said first spring carried within said first casing,
(3) a plate proximate to said first end of said first spring for securing said first end of said first spring to said casing,
(4) a cable having a first end and an opposing second end, said first end of said cable being connected to said second end of said first spring, and said second end of said cable being connected to said trailer, said first end of said cable having a direction parallel to said first spring,
(5) a pulley proximate to said second end of said first spring for changing said direction of said cable, and
(6) a direction pulley bracket rotatably carried by said second end of said casing, said direction pulley bracket carrying said pulley therein, said second end of said cable running over said pulley through said direction pulley bracket to said trailer.

9. The trailer as recited in claim 8, further comprising a second spring carried concentrically within said first spring, said second spring having a first end and a second end, said first end of said second spring being secured to said casing, said second end of said second spring being secured to said first end of said cable.

10. The trailer as recited in claim 8, wherein said plate has a hole formed therein and wherein said trailer further comprises a chain having a first end and an opposing second end, said first end being secured to said plate through said hole and said second end being secured to said first end of said first spring.

11. The trailer as recited in claim 8 further comprising a cover carried by said lift gate covering said casing.

12. The trailer as recited in claim 8, wherein said lift gate pivots about an axis and wherein said casing has an axis parallel to said axis of said lift gate.

13. The trailer as recited in claim 8, wherein said at least one lift gate assist mechanism further comprises two lift gate assist mechanisms.

14. The trailer as recited in claim 13, wherein said two lift gate assist mechanisms are carried in an opposing relationship.

15. The trailer as recited in claim 13, wherein said two lift gate assist mechanisms are oriented parallel to each other.

16. A method for adding at least one lift gate assist mechanism to a trailer with a lift gate having an inside and an opposing outside and pivoting between a closed position and an open position, said lift gate assist mechanism having at least one spring having a first end and an opposing second end, means proximate to said first end of said at least one spring for securing said first end of said at least one spring, a cable having a first end and an opposing second end, said first end of said cable being connected to said second end of said at least one spring, said first end of said cable having a direction parallel to said at least one spring, and a pulley proximate to said second end of said at least one spring for changing said direction of said cable, said method comprising the steps of:
(a) attaching said second end of said cable of said lift gate assist mechanism to a first point on said trailer; and
(b) attaching said lift gate assist mechanism to said outside of said lift gate at a second point no lower on said lift gate than said first point is on said trailer when said lift gate is in a closed position.

17. The method as recited in claim 16, further comprising the step of installing a bracket on said trailer to attach said second end of said cable of said lift gate assist mechanism.

18. The method as recited in claim 16, further comprising the steps of:
(a) attaching a second end of a cable of a second lift mechanism to a third point on said trailer, said third point being spaced apart from said first point, and
(b) attaching said second lift mechanism to said outside of said lift gate at a fourth point no lower on said lift gate than said third point is on said trailer when said lift gate is in a closed position.

19. The method as recited in claim 16, wherein said at least one spring is two springs, a first spring and a second spring, and further comprising the steps of:
(a) inserting said second spring inside said first spring, and
(b) attaching said two springs to said securing means and to said first end of said cable.

20. The method as recited in claim 19, wherein said securing means further comprises a plate with a hole formed therein and a chain having a first end and an opposing second end, said first end extending through said hole in said plate, said second end of said chain being attached to said first ends of said two springs, and wherein said method further comprises the step of adjusting tension on said two springs by pulling said chain through said hole.
